(19) United States
(12) Patent Application Publication
(10) Pub. No.: US 2008/0202438 A1
(43) Pub. Date: Aug. 28, 2008

(54) Motion-activated pet watering apparatus with digital fluid-flow valve

(76) Inventors: Thomas G. Engel, Columbia, MO (US); Victoria A. Engel, Columbia, MO (US)

Correspondence Address: THOMAS GREGORY ENGEL, 408 NORTH VILLAGE CIRCLE, COLUMBUS, MO, 65203, US

(21) Appl. No.: 12/072,308

(22) Filed: Feb. 26, 2008

Related U.S. Application Data
(60) Provisional application No. 60/903,386, filed on Feb. 26, 2007.

(51) Int. Cl. A01K 7/06

(52) U.S. Cl. 119/72

(57) ABSTRACT

A motion activated pet drinking apparatus which attaches to both indoor (i.e., sink) and outdoor water faucets and is activated by the motion of the pet to deliver a measured supply of fresh tap water for the pet's consumption. Upon activation, a fresh stream of tap water is directed in a suitable manner for the pet to drink. An electronic timer in the control circuitry shuts off the flow of water after a specified time, typically one minute. The apparatus does not store water and, therefore, does not collect algae, slime, or water deposits and requires only a minimal amount of cleaning. The absence of water storage minimizes cross-contamination when multiple pets use the apparatus. The apparatus is highly energy efficient due to the unique digital control valve used and can easily be powered from standard off-the-shelf commercial batteries. Household power (120 VAC) can also be used to power the apparatus if a nearby source is available. The apparatus has an in-line two-stage water filter and electric heating elements. The two-stage in-line filter is an optional component to filter particulate matter, chemicals, and bad tastes often found in public water supplies. The electric heating elements prevent freezing when the apparatus is used outdoors in low temperatures. Since the electric heating elements consume a relatively large amount of energy, the outdoor model of the apparatus requires 120 VAC household power source.

### RELATED APPLICATIONS

This application claims priority under 35 U.S.C. 119(e) to U.S. Provisional Application Ser. No. 60/903,386, entitled “Motion-Activated Pet Watering Device with Digital Fluid-Flow Valve,” filed on Feb. 26, 2007, which is herein incorporated by reference in its entirety.

### STATEMENT REGARDING FEDERALLY SPONSORED RESEARCH

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

The present invention relates to drinking or watering apparatus for pets such as cats and dogs that provides fresh drinking water from both indoor and outdoor faucets. There are various types of automatic pet drinking apparatus that have been patented. The existing state-of-technology can be seen in recent U.S. Pat. No. 6,928,954 (August 2005, Krishnamurthy), U.S. Pat. No. 7,146,930 (December 2000, Ness), and U.S. Pat. No. 7,270,082 (September 2007, Plante). The existing state-of-technology has a water reservoir that creates problems in that it requires constant filling, cleaning, and maintenance. The water reservoir also contributes to the bacterial and viral growth, especially when used by multiple pets, and does not encourage pets to drink since the water is stale and warm.

### SUMMARY OF THE INVENTION

The motion-activated pet watering apparatus with digital fluid-flow valve automatically dispenses a measured amount of fresh tap water for a pet, such as a cat or dog, to consume from both indoor and outdoor faucets. Clean, fresh water encourages pets to drink to remain well hydrated, an acute problem for outdoor pets. Compared to existing technology, the invention has no water reservoir to collect mold, slime, and algae and requires only minimal cleaning. The absence of a water reservoir also reduces the possibility of cross-contamination when the invention is used by multiple pets. The invention does not impede the normal use of the faucet.

The invention has provisions for an optional water filter to remove particulate matter, chemicals, and bad tastes from the tap water thereby further encouraging pets to drink more water to remain well-hydrated. The invention has a thermoelectric motion sensor to detect the pet's presence and to activate the apparatus. The motion sensor can be positioned a full 360 degrees to accommodate a wide variety of indoor and outdoor installations and a wide variety of pet drinking habits. The amount pet drinking water is controlled with an electronic timer in the control circuitry. Pet drinking water flow rate is user adjustable.

The invention uses a high efficiency digital fluid control valve allowing it to be powered by commercial batteries. The digital fluid control valve is high efficiency since it requires only a short electrical pulse to activate/deactivate and consumes no electrical power to remain in the activated or deactivated state. Existing electrically-operated fluid control valves consume relatively large amounts of power to remain in the activated or deactivated state. For the pet owner's convenience, 120 VAC household power can also be used to power the invention as a replacement to the battery pack or as a recharge source for the battery pack. Outdoor models of the invention have built-in electric heating elements to prevent freezing so that it may be used outdoors in cold climates. Outdoor use in cold climates dictates the use of a 120 VAC household power source due to the relatively large power consumption of the electric heating elements.

### DRAWINGS

The accompanying drawings are not intended to be drawn to scale. Not every component may be labeled in the drawings for purposes of clarity. In the drawings:

FIG. 1 is a side cross-sectional view of one embodiment of the motion-activated pet watering apparatus with digital fluid-flow valve showing its major components.

FIG. 2 is a side cross-sectional view of the digital fountain control valve showing its major components.

FIG. 3 is side plan view of one embodiment of the motion-activated pet watering apparatus with digital fluid-flow valve attached to a standard indoor water faucet.

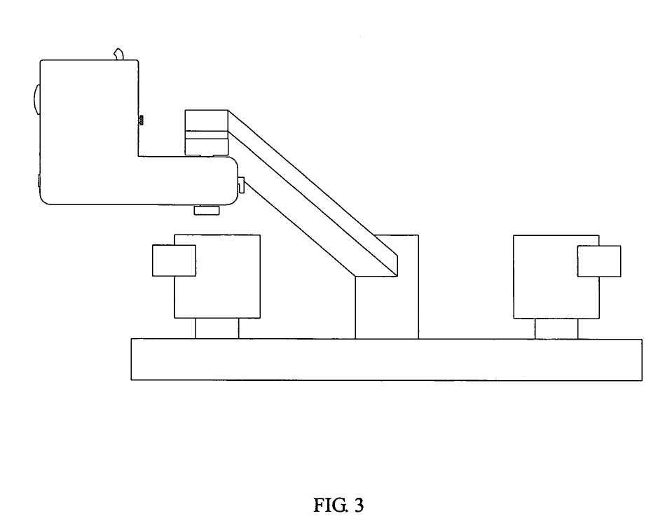

### DESCRIPTION OF THE INVENTION

The invention is not limited in its application to the construction details set forth in the following description or as illustrated in the drawings. The invention is capable of other embodiments and of being practiced or of being carried out in various ways to accomplish the same function. The terminology and phraseology used herein is for the purpose of description and should not be considered as limiting. The use of “including,” “comprising,” “having,” “containing,” “involving,” and variations thereof herein, is meant to encompass the items listed thereafter and equivalents thereof as well as additional items.

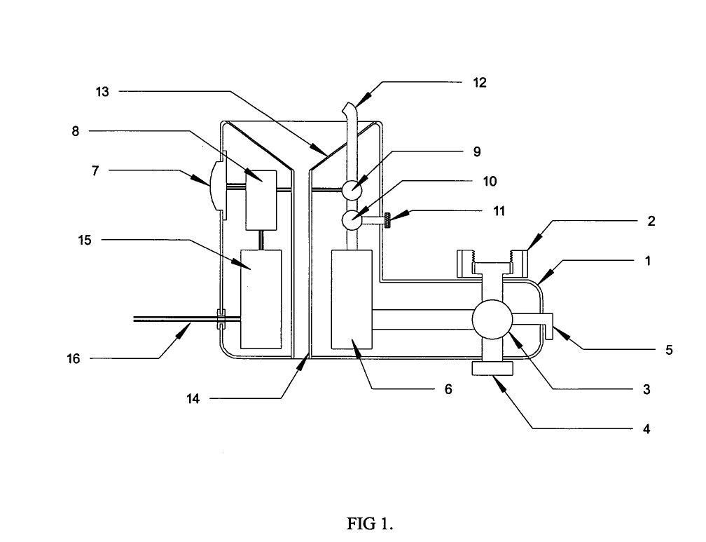

The motion-activated pet watering apparatus with digital fluid-flow valve of the present invention is shown in FIG. 1. The apparatus is contained in housing 1. Housing 1 can be constructed from a wide variety of materials that offer appropriate mechanical strength and corrosion resistance, including stainless steel, aluminum, plastic, or composite. The apparatus is connected to either a standard indoor or outdoor water faucet with supplied mounting nut and adapter(s) 2. After the apparatus is connected to either the indoor or outdoor faucet, the faucet valve is opened. The indoor or outdoor water faucet remains operational even though the apparatus has been connected to the indoor or outdoor faucet. The user is able to control water flow via a bi-directional valve 3 either through the aerator 4 for normal faucet use or to the apparatus itself for pet use by positioning the bi-directional valve handle 5 in one of its two positions. Drinking water for the pet is cleaned by a water filter 6. The purpose of the water filter 6 is to remove particulate matter, chemicals, and/or bad tastes from the water supply and can be single-stage or multi-state construction. The water filter 6 can be serviced or replaced by the user via an opening on the underside of the apparatus. The water filter 6 is an optional component of the apparatus may be excluded. The thermoelectric motion sensor 7 is activated when the pet approaches the apparatus which, in turn, activates the digital fountain control valve 8 and starts an electronic timer in the control circuitry 9. The digital fountain control valve 8 requires only a short electrical pulse to activate. The electronic timer in the control circuitry 9 automatically sends a short electrical pulse to deactivate the digital fountain control valve 8. The electrical pulses that activate and deactivate the digital fountain control valve 8 have the same polarity. The flow rate of the pet's drinking water is controlled by the user via the fountain flow rate valve 10 and the fountain rate adjustment screw 11. Water exits from the fountain spout 12 for the pet to drink. The basin 13 directs water to the apparatus drain 14. If the apparatus is used indoors, the water flows from the apparatus drain 14 into the sink's drain and, if used outdoors, flows onto the ground (not shown in FIG. 1), a separate catch basin (not shown in FIG. 1), or through a separate drain tube (not shown in FIG. 1) to any location the user desires (not shown in FIG. 1). The apparatus can be powered by either an internal battery pack 15 or by AC household power through an external wall-transformer and cable 16. The internal battery pack can be serviced or replaced via an access door located on the bottom of the apparatus. The battery pack 15 can be charged via the external wall-transformer and cable 16, if desired, eliminating the need to remove the battery pack 15. The housing 1 is constructed so that it can be rotated to position the motion sensor 7 so as to accommodate the pet's drinking position (i.e., left or right side of the sink) and to minimize false triggering of the motion sensor 7. The fountain spout 12 also rotates independently to accommodate the pet's drinking position. Outdoor models of the apparatus must endure low temperatures and contain electric heating elements (not shown in FIG. 1) located in housing 1 and near or around water delivery structures (3, 9, 10, 12) to prevent freezing. Outdoor models of the apparatus should be powered by 120 VAC due to the relatively high power consumption of the electric heating elements that cannot be provided by existing commercial batteries. Outdoor models of the apparatus also require the housing to be thermally insulated (not shown in FIG. 1) to minimize power consumption.

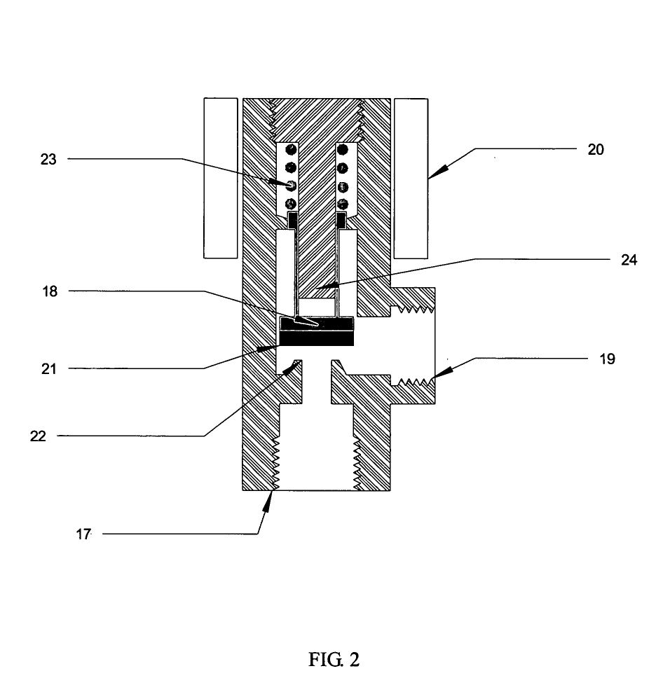

One embodiment of the digital fountain control valve 8 is shown in FIG. 2. Although shown as a separate device for the purpose of description, the digital fountain control valve 8 in FIG. 2 can be made part of the apparatus housing 1. If implemented as a separate entity, the digital fountain control valve 8 can be constructed from a wide variety of materials that offer appropriate mechanical strength and corrosion resistance, including stainless steel, aluminum, plastic, or composite. Water enters the digital fountain control valve through the inlet port 17. The click-plunger 18 allows water flow through the valve to the outlet port 19. The click-plunger's mechanical action is identical to that found in common click-writing pens. The click-plunger is made from a ferromagnetic material and moves when a current is applied to induction coil 20 under magnetic forces present. The click-plunger has a rubber gasket 21 that seals against valve seat 22 with the aid of spring 23 when in the down position. The click-plunger's up and down movement is controlled by travel guide 24.

What is claimed is:

1. A motion-activated pet watering apparatus with digital fluid-flow valve consisting of
a housing
adapters and fittings
a bi-directional valve
a water filter
a thermoelectric motion sensor
a digital fountain control valve
electronic control and timing circuitry
a fountain flow rate valve with fountain flow rate screw
a fountain spout
a basin
a drain
an internal battery pack and/or a wall-transformer and cable electric heating elements.

2. The adapter and fittings in claim 1 allow the motion-activated pet watering apparatus with digital fluid-flow valve to be connected to indoor and outdoor faucets.

3. The fountain spout in claim 1 is independently rotatable allowing optimal positioning of fountain spout from which the pet drinks.

4. The thermoelectric motion sensor in claim 1 is independently rotatable allowing optimal positioning of motion sensor to detect pet's presence and minimize the occurrence of false triggers.

5. The bi-directional valve in claim 1 allows water supply to be directed to the aerator thereby not impeding normal faucet use.

6. The water filter in claim 1 filters particulate matter, chemicals, and bad tastes from tap water encouraging pets to drink more often.

7. The electronic control and timing circuitry in claim 1 provides a timed delivery of pet drinking water.

8. The basin in claim 1 directs waste water to the drain.

9. The drain in claim 1 directs waste water out of the motion-activated pet watering apparatus with digital fluid-flow valve.

10. The electric heating elements in claim 1 prevents water freezing in the motion-activated pet watering apparatus with digital fluid-flow valve and allows the motion-activated pet watering apparatus to be used outdoors in low temperatures.

11. The digital fountain control valve in claim 1 consists of
a water inlet port
a click-plunger with rubber gasket
a water outlet port
a valve seat
a travel guide

12. The digital fountain control valve in claim 11 is pulse-operated and highly energy efficient allowing the motion-activated pet watering apparatus with digital fluid-flow valve to operate over long periods of time with commercial batteries.

13. The digital fountain control valve in claim 11 can be a separate component or can be part of the housing in claim 1.

14. The motion-activated pet watering apparatus with digital fluid-flow valve in claim 1 automatically dispenses a measured amount of fresh supply of pet drinking water.
